(19) United States
(12) Patent Application Publication
(10) Pub. No.: US 2005/0248691 A1
(43) Pub. Date: Nov. 10, 2005

(54) Optical engine apparatus

(76) Inventor: Kyoung-choul Jang, Suwon-si (KR)

Correspondence Address: STANZIONE & KIM, LLP, 919 18TH STREET, N.W., SUITE 440, WASHINGTON, DC, 20006, US

(21) Appl. No.: 11/123,005

(22) Filed: May 6, 2005

(30) Foreign Application Priority Data
May 8, 2004 (KR) 2004-32513

(51) Int. Cl. H04N 5/64

(52) U.S. Cl. 348/744

(57) ABSTRACT

An optical engine apparatus to magnify and project an image beam formed by a display device on a screen includes a light source to emit light, an optical path transformation unit provided on an optical path between the light source and the display device to transform a path of the light from the light source toward the display device, and an accommodating unit in which the optical path transformation unit is accommodated, to form the path of the light in the optical path transformation unit. With this configuration, the optical engine apparatus minimizes a loss of the light generated from the light source and projected to the display device, and improves a brightness of a picture corresponding to the image beam. The optical path transformation unit is accommodated in an accommodation casing to minimize leaking of the light thereby maintaining a good quality of the picture and protecting the optical engine apparatus from contamination due to dust or foreign substances.

### CROSS-REFERENCE TO RELATED APPLICATIONS

This application claims the benefit of Korean Patent Application No. 2004-32513 filed on May 8, 2004 in the Korean Intellectual Property Office, the disclosure of which is incorporated herein in its entirety and by reference.

### BACKGROUND OF THE INVENTION

1. Field of the Invention

The present general inventive concept relates to an optical engine apparatus used with a projection apparatus, and more particularly, to an optical engine apparatus to minimize loss of light generated from a light source and projected to a display device.

2. Description of the Related Art

An optical engine apparatus projects light emitted from a light source toward a display device, such as liquid crystal display (LCD) or digital micro-mirror display (DMD), so as to form an image beam, and displays a picture on a screen by magnifying and projecting the image beam onto the screen.

As an example of the optical engine apparatus, an optical engine assembly is disclosed in Korean Patent First Publication No. 2003-78216, the optical engine assembly comprising a light source emitting light, a color wheel transmitting the light emitted from the light source therethrough selectively according to wavelengths of the light, a uniform light generator controlling the light transmitted through the color wheel to be uniform, an optical path transformation unit transforming a path of the light traveling via the uniform light generator toward a display device, a prism reflecting the light traveling via the optical path transformation unit toward the display device, the display device forming an image beam, and a projecting system magnifying and projecting the image beam formed by the display device onto a screen.

Here, the optical path transformation unit comprises a reflection mirror to reflect the light traveling via the uniform light generator, a first lens to focus the light, another reflection mirror to transform the path of the light traveling via the first lens toward the prism, and a second lens to focus the light into the prism.

However, in such a conventional optical engine assembly, the foregoing configurations (components) are assembled into the optical path transformation unit, but fixed to respectively separate positions, thereby causing problems of degrading quality of the light because the light leaks outside, and decreasing quantity of the light since dust and foreign substance adhere to the components and darken the screen.

### SUMMARY OF THE INVENTION

In order to solve the foregoing and/or other problems, it is an aspect of the present general inventive concept to provide an optical engine apparatus to minimize loss of light generated from a light source and projected to a display device, and to improve brightness an image formed by the projected light.

According to another aspect of the present general inventive concept, an optical path transformation unit is accommodated in an accommodation casing to minimize leaking of the light to thereby maintain a good quality of the image and protect the optical engine apparatus from contamination due to dust or foreign substances.

Additional aspects and/or advantages of the invention will be set forth in part in the description which follows and, in part, will be obvious from the description, or may be learned by practice of the invention.

The foregoing and/or other aspects of the present general inventive concept may be achieved by providing an optical engine apparatus to magnify and project an image beam formed by a display device on a screen, the optical engine apparatus comprising a light source to emit light, an optical path transformation unit provided on an optical path between the light source and the display device to transform a path of the light from the light source toward the display device, and an accommodating unit to accommodate the optical path transformation unit to form the path of the light in the optical path transformation unit.

According to an aspect of the present general inventive concept, in a first side of the accommodating unit is provided an incoming hole through which the light from the light source passes, and in a second side of the accommodating unit is provided an outgoing hole through which the light transmitted into the accommodating unit and passing through the incoming hole exits the optical path transformation unit.

According to another aspect of the present general inventive concept, the optical path transformation unit comprises a first reflection mirror to reflect the light from the light source, a relay lens to focus the light reflected by the first reflection mirror, and a second reflection mirror to reflect the light passing through the relay lens toward the display device.

According to yet another aspect of the present general inventive concept, the optical engine apparatus further comprises a color wheel to which the light from the light source is transmitted, and a uniform light generator to uniformize the light passing through the color wheel and to emit the uniformized light to the accommodating unit.

According to still another aspect of the present general inventive concept, the accommodating unit comprises a first accommodating unit and a second accommodating unit coupled to each other to form the path of the light in the optical path transformation unit.

According to an another aspect of the present general inventive concept, the first accommodating unit comprises the incoming hole in which a light tunnel assembly is disposed, a first passing hole in which the first reflection mirror to reflect the light passing through the incoming hole to the relay lens is disposed, and a mounting hole in which the relay lens is disposed, and the second accommodating unit comprises a through hole through which the light passed through the relay lens is transmitted into the second accommodating unit, a second passing hole in which a second reflection mirror to reflect the light passing through the through hole is provided, and an outgoing hole through which the light reflected by the second reflection mirror is emitted toward the display device.

According to another aspect of the present general inventive concept, the optical engine apparatus further comprises a prism provided on the optical path formed between the optical path transformation unit and the display device to transmit the light emitted from the outgoing hole of the second accommodating unit.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view illustrating an optical engine apparatus used with a projection television apparatus according to an embodiment of the present general inventive concept;

FIG. 2 is an exploded perspective view illustrating the optical engine apparatus in FIG. 1;

FIG. 3 is a view illustrating an optical path transformation unit mounted in an optical engine accommodating casing in the optical engine apparatus in FIG. 2; and

FIG. 4 is an exploded perspective view illustrating the optical path transformation unit in FIG. 3.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

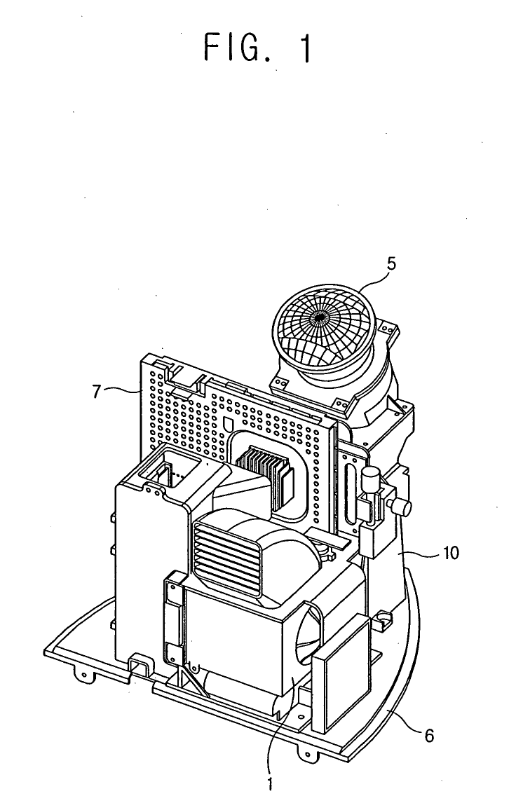

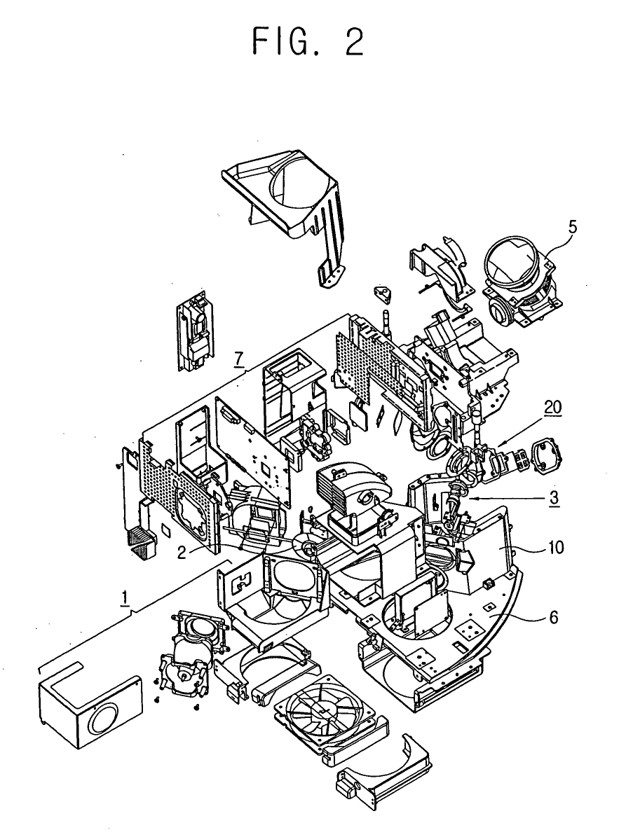

As shown in FIGS. 1 and 2, an optical engine apparatus may comprise a light source 1 to generate light, a DMD panel 7 used as a display device on which the light emitted from the light source 1 is projected to form an image beam, and a projector 5 to magnify and project the image beam generated by the display device 7 to a screen of a projection television.

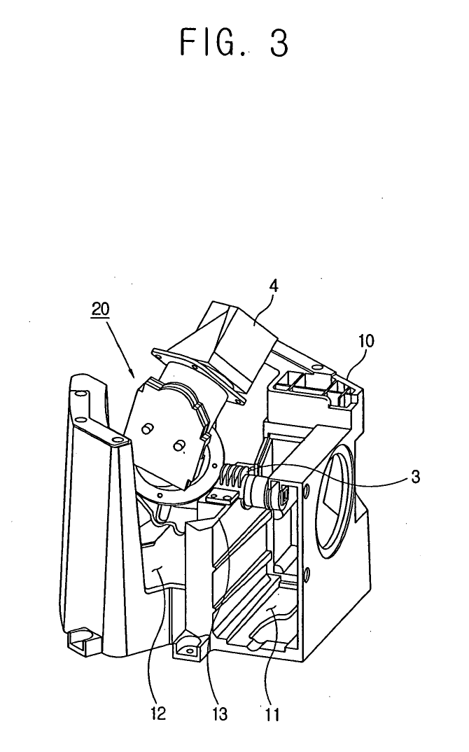

Further, the optical engine apparatus may comprise a color wheel assembly 2 having a color wheel to selectively sort the light from the light source 1 into red (R), green (G) and blue (B) light a light tunnel assembly 3 having a light tunnel used as a uniform light generator to make the light beam passing through the color wheel assembly 2 have a planar form like a surface of the DMD panel 7, and an optical path transformation assembly 20 to transform a path of the light traveling via the light tunnel assembly 3 toward the DMD panel 7, and a prism 4 (FIG. 3) assembled to the optical path transformation assembly 20. Here, the light source 1 can be seated on a base 6, and an optical unit accommodation casing 10 can be placed behind the light source 1 and coupled to the base 6. The optical unit accommodation casing 10 can be partitioned by a partition 13 (FIG. 3) into a first accommodating portion 11 to which the color wheel assembly 2 is mounted, and a second accommodating portion 12 to which the optical path transformation assembly 20 is mounted.

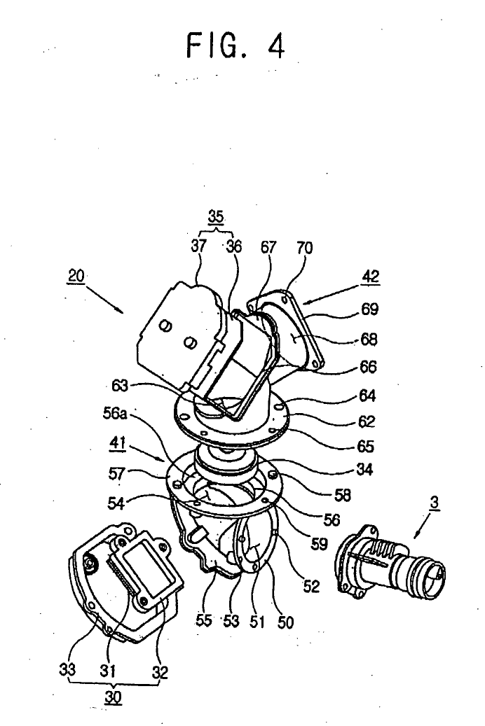

As shown in FIGS. 3 and 4, the optical path transformation assembly 20 can include a first side coupled with the prism 4, and a second side accommodated in the second accommodating portion 12 and connected to the light tunnel assembly 3 mounted to the partition 13.

The optical path transformation assembly 20 can be provided on an optical path between the light tunnel assembly 3 and the prism 4 to transform the path of the light passing through the light tunnel assembly 3 toward the prism 4, so that the light travels toward the DMD panel 7 by the prism 4.

The optical path transformation assembly 20 may comprise optical path transformers 30, 34, and 35 to transform the path of the light passing through the light tunnel assembly 3 toward the DMD panel 7 by the prism 4, and accommodating units 41 and 42 to accommodate the optical path transformers 30, 34, and 35 and to form the optical path therein with the optical path transformers 30, 36, and 37.

The optical path transformers 30, 34, and 35 may be referred to as a first reflection mirror assembly 30 to reflect the light, which is emitted from the light source 1 and passes through the color wheel assembly 2 and the light tunnel assembly 3, a relay lens 34 to focus the light passing through the light tunnel assembly 3 and reflected from the first reflection mirror 31 to thereby enhance a brightness of an image corresponding to the image beam, and a second reflection mirror assembly 35 to reflect the light passing through the relay lens 34 toward the prism 4.

The first reflection mirror assembly 30 may comprise a first reflection mirror 31 to reflect the light passing through the light tunnel assembly 3 toward the relay lens 34, a supporting bracket 32 having a through hole in the center thereof and surrounding edges of the first reflection mirror 31, and a first reflection mirror cover 33 to cover a back of the first reflection mirror 31.

The second reflection mirror assembly 35 may comprise a second reflection mirror 36 to reflect the light passing through the relay lens 34 toward the prism 4, and a second reflection mirror cover 37 to cover a back of the second reflection mirror 36. Here, the prism 4 can reflect the light reflected from the second reflection mirror 36 toward the DMD panel 7 and can transmit and project the image beam corresponding to the light reflected from the DMD panel 7 toward a projecting lens of the projector 5.

The accommodating units 41 and 42 can be shaped like a hollow pipe to accommodate the optical path transformers 30, 34, and 35, can comprise the first reflection mirror assembly 30, the relay lens 34 and the second mirror assembly 35 therein, and can form the optical path with the optical path transformers 30, 34, and 35. Further, the accommodating units 41 and 42 can be respectively formed with an incoming hole 51 through which the light passing through the light tunnel assembly 3 enters the optical path transformation assembly 20, and an outgoing hole 68 through which the light traveling via the optical path transformers 30, 34, and 35 exits from the optical path transformation assembly 20.

The accommodating units 41 and 42 may comprise a first accommodating unit 41 and a second accommodating unit 42, which are coupled to each other and form the optical path of the optical path transformers 30, 34, and 35. The first accommodating unit 41 can be coupled with the light tunnel assembly 3, the first reflection mirror assembly 30 and the relay lens 34. The second accommodating unit 42 can be coupled with the second reflection mirror assembly 35 and the prism 4.

The first accommodating unit 41 may comprise the incoming hole 51 to communicate with the light tunnel assembly 3 and allowing the light traveling via the light tunnel assembly 3 to enter the optical path transformation assembly 20, a first coupling flange 50 extended along a circumference of the incoming hole 51, a first through hole 54 coupled to the first reflection mirror assembly 30 and allowing the first reflection mirror assembly 30 to be inclined with respect to the incident light entering the optical path transformation assembly 20 through the incoming hole 51, a second coupling flange 55 extended along a circumference of the first through hole 54, a mounting hole 56 to receive the relay lens 34, and a third coupling flange 57 extended along a circumference of the mounting hole 56.

The incoming hole 51 can be formed in the first accommodating unit 41 at a position aligned with the path of the light passing through the uniform light tunnel assembly 3 to introduce the light passing through the light tunnel assembly 3 into the first accommodating unit 41.

The first coupling flange 50 may comprise a coupling projection 52 protruding from a planer surface thereof and inserted into a coupling groove (not shown) of the light tunnel assembly 3, and a plurality of first coupling holes 53 through which screws passing through each through hole (not shown) of the light tunnel assembly 3 are coupled to the first coupling flange 50.

The first through hole 54 can be formed in the first accommodating unit 41 to be inclined with respect to the incident light entering through the incoming hole 51, and the first reflection mirror 31 is exposed between the first through hole 54 and the incoming hole 51 to reflect the light passing through the incoming hole 51 to the relay lens 34.

The mounting hole 56 can be formed in a center of the first accommodating unit 41 to receive the relay lens 34 disposed between the first accommodation unit 41 and the second accommodating unit 42. That is, the relay lens 34 is accommodated in the mouting hole 56 and supported by an inside wall 56a of the mounting hole 56.

The third coupling flange 57 may comprise a second coupling projection 58 protruding from a planer surface thereof and inserted into a coupling groove formed in the fourth coupling flange 62 of the second accommodating unit 42, and a plurality of second coupling holes 59 formed on a planer surface thereof so that the third coupling flange is coupled to the fourth coupling flange 62 through the second coupling holes 59 and a plurality of third coupling holes 65 of the fourth coupling flange 62 of the second accommodating unit 42 by screws (not shown).

The second accommodating unit 42 may comprise a passing hole 63 through which the light passing through the relay lens 34 is projected into the second accommodating unit 42, the fourth coupling flange 62 extended along a circumference of the passing hole 63 and coupled to the third coupling flange 57, a second through hole 66 through which the second reflection mirror assembly 35 is coupled to the second accommodating unit 42, and in which the second reflection mirror assembly 35 is disposed to be inclined with respect to the incident light entering through the passing hole 63, a fifth coupling flange 67 extended along a circumference of the second through hole 66, an outgoing hole 68 through which the light emits from the second accommodating unit 42 so that the light reflected by the second reflection mirror 36 can enter the prism 4, and a sixth coupling flange 69 extended along a circumference of the outgoing hole 68, formed with a fourth coupling hole 70, and coupled to the prism 4 through the fourth coupling hole 70.

The passing hole 63 can be formed on the second accommodating unit 42 at a position corresponding the mounting hole 56 to allow the light passing through the relay lens 34 to enter the second accommodating unit 42.

The fourth coupling flange 62 can be formed on the planer surface of the fourth coupling flange 62 and may comprise a plurality of first projection grooves 64 into which the second coupling projections 58 are coupled, and a plurality of third coupling holes 65 formed on the planer surface of the fourth coupling flange 62 so that the fourth coupling flange 62 is coupled to the third coupling flange 57 through the third coupling holes 65 and the second coupling holes 59 of the third coupling flange 57 by the screw.

The second reflection mirror assembly 35 can be inclined with respect to the path of the light passing through the relay lens 34, and the second reflection mirror 36 to reflect the light transmitted from the relay lens 34 and passing through the passing hole 63 to the prism 4 can be exposed to the relay lens 34 and prism 4 in the second accommodating unit 42 through the second through hole 66.

An assembling process of the optical path transformation assembly 20 with the above configuration will be described hereinbelow.

The first coupling flange 50 of the first accommodating unit 41 can be coupled with the light tunnel assembly 3 by inserting the first coupling projection 52 into the coupling groove of the light tunnel assembly 3 and by inserting the screw into the through hole of the light tunnel assembly 3 and the first coupling hole 53 of the first coupling flange 50 in a state that the incoming hole 51 of the first accommodating unit 41 is aligned with the light tunnel assembly 3. Thus, the first accommodating unit 41 can communicate with the light tunnel assembly 3 through the incoming hole 51.

The supporting bracket 32 can be coupled to a front of the first reflection mirror 31, thereby supporting the circumference of the first reflection mirror 31. Then, the first reflection mirror cover 33 from the back of first reflection mirror 31 can be coupled to the second coupling flange 55, so that the first reflection mirror 31 of the first reflection mirror assembly 30 is exposed through the first through hole 54 within the first accommodating unit 41.

Further, the relay lens 34 can be disposed in the mounting hole 56 formed in an upper portion of the first accommodating unit 41, and then the third coupling flange 57 of the first accommodating unit 41 is coupled with the fourth coupling flange 62 of the second accommodating unit 42 in a state that the mounting hole 56 of the first accommodating unit 41 communicates with the passing hole 63 of the second accommodating unit 42. Here, the second coupling projection 58 of the third coupling flange 57 can be inserted into the first projection groove 64, and the screw is inserted into the second coupling hole 59 of the third coupling flange and the third coupling hole 65 of the fourth coupling flange 62.

Then, the second reflection mirror 36 can be mounted to the second accommodating unit 42 through the second through hole 66, so that the second reflection mirror 36 is exposed through the second through hole 66 of the second accommodating unit 42 within the second accommodating unit 42. Then, the second reflection mirror cover 37 from the back of the second reflection mirror 36 can be coupled with the fifth coupling flange 67, and the prism 4 can be coupled to the sixth coupling flange 69 of the second accommodating unit 42 in correspondence to the outgoing hole 68, thereby completing the assembling process of the optical path transformation assembly 20.

Thus, when the light is emitted from the light source 1, the light can travel via the color wheel assembly 2 and the light tunnel assembly 3. The light passing through the light tunnel assembly 3 can enter the inside of the first accommodating unit 41 via the incoming hole 51 of the optical path transformation assembly 20. The incident light can be reflected from the first reflection mirror 31 exposed in the first accommodating unit 41 and can travel toward the relay lens 34. Then, the light can be transmitted through the relay lens 34 and the passing hole 63 to enter the inside of the second accommodating unit 42. Then, the incident light can be reflected from the second reflection mirror 36 exposed in the second accommodating unit 42 and can travel toward the prism 4 through the outgoing hole 68 of the second accommodating unit 42. The light reflected from the prism 4 can travel toward the DMD panel 7. Then, the light can be reflected again from the DMD panel 7 toward the prism 4, and can be transmitted through the prism 4, thereby traveling toward the projector 5. Then, the projector 5 can magnify and project the light onto the screen, thereby displaying a picture on the screen.

As described above, the present general inventive concept provides an optical path transformation assembly 20 comprising the first reflection mirror 31, the relay lens 34 and the second reflection mirror 36, and transforming the path of the light from the light source 1 toward the DMD panel 7 in the optical unit accommodating casing thereby minimizing a loss of the light and enhancing a brightness of the picture.

In addition, according to the present general inventive concept, the path of the light can be formed within the accommodating unit by the first reflection mirror 31, the relay lens 34 and the second reflection mirror 36, thereby minimizing leaking of the light to maintain a good quality of the picture.

Further, the optical path transformation assembly 20 comprising the first reflection mirror 31, the relay lens 34 and the second reflection mirror 36 is accommodated in the optical unit accommodation casing 10 to protect from contamination due to dust or foreign substances.

Although a few embodiments of the present invention has been shown and described, it will be appreciated by those skilled in the art that changes may be made in these embodiments without departing from the principles and spirit of the invention, the scope of which is defined in the appended claims and their equivalents.

1. An optical engine apparatus to magnify and project an image beam formed by a display device on a screen, the optical engine apparatus comprising:
a light source to emit light;
an optical path transformation unit provided on an optical path between the light source and the display device to transform a path of the light from the light source toward the display device; and
an accommodating unit to accommodate the optical path transformation unit, and to form the path of the light in the optical path transformation unit.

2. The optical engine apparatus of claim 1, wherein the accommodating unit comprises a first side having an incoming hole through which the light from the light source passes, and a second side having an outgoing hole through which the light transmitted into the accommodating unit through the incoming hole exits the optical path transformation unit.

3. The optical engine apparatus of claim 2, wherein the optical path transformation unit comprises:
a first reflection mirror to reflect the light from the light source;
a relay lens to focus the light reflected by the first reflection mirror; and
a second reflection mirror to reflect the light passing through the relay lens toward the display device.

4. The optical engine apparatus of claim 3, further comprising:
a color wheel to which the light from the light source is transmitted; and
a uniform light generator to uniformize the light passing through the color wheel and to emit the uniformized light to the accommodating unit.

5. The optical engine apparatus of claim 4, wherein the accommodating unit comprises a first accommodating unit and a second accommodating unit coupled to each other to form the path of the light in the optical path transformation unit.

6. The optical engine apparatus of claim 5, wherein the first accommodating unit comprises the incoming hole in which a light tunnel assembly is disposed, a first passing hole in which the first reflection mirror reflecting the light passed through the incoming hole to the relay lens is disposed, and a mounting hole to receive the relay lens, and
the second accommodating unit comprises a through hole through which the light passing through the relay lens is transmitted into the second accommodating unit, a second passing hole in which the second reflection mirror to reflect the light passing through the through hole is provided, and the outgoing hole through which the light reflected by the second reflection mirror is emitted toward the display device.

7. The optical engine apparatus of claim 6, further comprising:
a prism provided on the optical path formed between the optical path transformation unit and the display device to transmit the light emitted from the outgoing hole of the second accommodating unit to the display device.

8. The optical engine apparatus of claim 1, further comprising:
a color wheel to which the light from the light source is transmitted; and
a uniform light generator to uniformize the light passing through the color wheel and to emit the uniformized light to the accommodating unit.

9. The optical engine apparatus of claim 8, wherein the accommodating unit comprises a first accommodating unit and a second accommodating unit coupled to each other to form the path of the light in the optical path transformation unit.

10. The optical engine apparatus of claim 9, wherein:
the optical path formation unit comprises a first reflection mirror, a relay lens, and a second reflection mirror; the first accommodating unit comprises an incoming hole to which a light tunnel assembly is disposed, a first passing hole in which the first reflection mirror reflecting the light passed through the incoming hole to the relay lens is disposed, and a mounting hole receive to the relay lens; and
the second accommodating unit comprises a through hole through which the light passing through the relay lens is transmitted into the second accommodating unit, a second passing hole in which the second reflection mirror to reflect the light passing through the through hole is provided, and an outgoing hole through which the light reflected by the second reflection mirror is emitted toward the display device.

11. The optical engine apparatus of claim 10, further comprising:
a prism provided on the optical path formed between the optical path transformation unit and the display device to transmit the light emitted from the outgoing hole of the second accommodating unit to the display device.

12. An optical engine apparatus used with a projection apparatus, comprising:
a first accommodating unit having a first coupling flange with an incoming hole to receive light emitted from a light source, a second coupling flange, a first reflection mirror assembly coupled to the second coupling flange to reflect the light transmitted through the incoming hole, and a third coupling flange with a mounting hole; and
a second accommodating unit having a fourth coupling flange coupled to the third coupling flange to receive the light reflected from the first reflection mirror assembly through the mounting hole, a fifth coupling flange, a second reflection mirror assembly coupled to the fifth coupling flange to reflect the light passing through the mounting hole, and a sixth coupling flange connectable to a prism and having an outgoing hole through which the light reflected from the second reflection mirror assembly is emitted to the prism.

13. The optical engine apparatus of claim 12, wherein the first accommodating unit comprises a hollow pipe formed with the first, second, and third coupling flanges, and the hollow pipe and the first, second, and third coupling flanges are made in a single monolithic body, the second coupling flange disposed between the first coupling flange and the third coupling flange.

14. The optical engine apparatus of claim 13, the second accommodating unit comprises a second pipe formed with the fourth, fifth, and sixth coupling flanges, and the second hollow pipe and the fourth, fifth, and sixth coupling flanges are made in a single monolithic body.

15. The optical engine apparatus of claim 13, wherein the first reflection mirror assembly is sealed to the monolithic body through the second coupling flange to protect from contamination of dust or foreign substance.

16. The optical engine apparatus of claim 13, wherein the first reflection mirror assembly comprises a reflection mirror and a reflection mirror cover having a first portion coupled to the reflection mirror and a second portion coupled to the second coupling flange.

17. The optical engine apparatus of claim 12, further comprising:
a relay lens disposed in the mounting hole to transform a path of the light reflected from the first reflection mirror assembly toward the second reflection mirror.

18. The optical engine apparatus of claim 17, wherein the relay lens is disposed between the first and second reflection mirror assemblies, and the first accommodating unit comprises a side wall defining the mounting hole to support the relay lens.

19. The optical engine apparatus of claim 17, wherein the first reflection mirror assembly, the relay lens, and the second reflection mirror assembly transform the path of the light within the first and second accommodating units.

20. The optical engine apparatus of claim 19, wherein the light is prevented from leaking from the first and second reflection mirror assemblies coupled to the second and fifth coupling flanges, respectively, while traveling along the optical path formed within the first and second reflection mirror assemblies from the incoming hole to the outgoing hole.
